(19) United States
(12) Patent Application Publication
(10) Pub. No.: US 2022/0103016 A1
(43) Pub. Date: Mar. 31, 2022

(54) Combination of Resolver and Inductive Rotor Supply in One Magnetic Circuit

(71) Applicant: Universität Stuttgart, Stuttgart (DE)

(72) Inventors: Jannis Noeren, Erligheim (DE); Andreas Gneiting, Stuttgart (DE); Nejila Parspour, Gerlingen (DE)

(21) Appl. No.: 17/487,971

(22) Filed: Sep. 28, 2021

(30) Foreign Application Priority Data
Sep. 29, 2020 (DE) 10 2020 212 268.7

(51) Int. Cl. H02J 50/12; H02P 6/18; H02K 24/00; H04B 5/00

(52) U.S. Cl. CPC H02J 50/12; H04B 5/0037; H02K 24/00; H02P 6/18

(57) ABSTRACT

The invention relates to a device for the contactless transfer of electric power to a load arranged on a rotor 20 of an electric machine and for detecting the angular position of the rotor 20. The device comprises an inductive power transfer path for the inductive transfer of electric power to the electrical load and a resolver for detecting an angular position of the rotor 20, wherein the inductive power transfer path and the resolver use one magnetic circuit.

The invention furthermore relates to a corresponding method and to a corresponding electric machine.

The invention relates to a device for the contactless transfer of electric power to a load arranged on a rotor of an electric machine and for detecting the angular position of the rotor. The invention also relates to a corresponding method and a corresponding electric machine.

In order to supply the rotor of an electric machine (e.g. a motor or a generator) with electric power, use is conventionally made of power transfer systems in which the electric power is transmitted via sliding contacts. This type of power transfer has numerous disadvantages, such as larger axial masses, higher maintenance cost, and heating. Electric machines with a contactless (e.g. inductive) power supply for the rotor are also known from the prior art.

Furthermore, resolvers or other rotor angle encoder for determining the angular position of the rotor are known from the prior art.

So far, the two functionalities (resolver or angular position measurement and contactless power transfer) have been implemented separately: resolver or other rotor angle encoder on the one hand and contactless rotor supply or other supply on the other. As a result, more installation space was required and the complexity and thus costs of the electrical synchronous machine were increased.

It is the object of the present invention to at least partially overcome the above-mentioned disadvantages and to provide an advantageous further development of a device having an power transfer function and an angular position measuring function.

This object is achieved by the subject matters of the independent claims. Preferred embodiments are subject of the subclaims.

The invention suggests combining the detection of the rotor angle or the angular position of the rotor (resolver or resolver function) and the contactless or brushless supply of the rotor with electric power.

A first aspect of the invention relates to a device for the contactless transfer of electric power to an electrical load arranged on a rotor of an electric machine and for detecting the angular position of the rotor. The device comprises:
an inductive power transfer path for the inductive transfer of electric power to the electrical load arranged on the rotor; and
a resolver for detecting an angular position of the rotor,
wherein the inductive power transfer path and the resolver use one (and the same) magnetic circuit or are located in one (and the same) magnetic circuit.

A second aspect of the invention relates to an electric machine comprising:
a rotor;
a stator; and
a device for the contactless transfer of electric power to an electrical load arranged on the rotor and for detecting the angular position of the rotor according to the first aspect.

A further aspect of the invention relates to a method for the contactless power transfer to an electrical load arranged on a rotor of an electric machine and for detecting the angular position of the rotor, comprising:
providing a device for the contactless transfer of electric power to an electrical load arranged on the rotor and for detecting the angular position of the rotor according to the first aspect; and
contactless power transfer to a on the rotor and detection of the angular position of the rotor by means of the device provided.

The present invention enables the rotor angle determination of an electric machine and a simultaneous inductive contactless supply of an electrical load on the rotor, such as a rotor winding or excitation winding of the rotor, a sensor, etc. This requires less installation space and reduces the complexity of the system overall. This leads to a reduction in costs. Compared to conventional rotor supplies with brushes, the proposed device works without wear. This leads to a further reduction in costs.

The term “electric machine” relates both to electrical motors and to electrical generators. The electric machine can be any rotating machine, such as a synchronous machine, asynchronous machine, etc.

The inductive power transfer path (IPT “Inductive Power Transfer”) can be an IPT path known per se. The inductive power transfer path comprises an power transmitter with at least one first coil (power transmitter coil or primary coil) and an power receiver with at least one second coil (power receiver coil or secondary coil), the power transfer taking place by means of induction from the at least one first coil (primary coil) to the at least one second coil (secondary coil). In particular, for inductive power transfer, an alternating magnetic field is generated in the transmitter, e.g. by means of an oscillator that works as an inverter. The secondary coil is permeated with the alternating magnetic field by the primary coil, which induces an alternating voltage in the secondary coil. The alternating voltage can be used in a rectified manner to supply an electrical load. In the case of an inductive power transfer path for the inductive transfer of electric power to a load on the rotor of an electric machine, the at least one first coil (primary coil) is arranged on the stator side (e.g. in/on the stator, or (fixedly) connected to the stator). The at least one second coil (secondary coil) is arranged on the rotor side (e.g. in/on the rotor, or (fixedly) connected to the rotor).

A resolver is an electromagnetic transducer for converting the angular position of a rotating object (such as a rotor) into an electrical variable, which is measured using a suitable measuring device. The resolver can comprise at least one signal receiver coil or measuring coil, which is used to measure the angular position of the rotor.

The at least one signal receiver coil or measuring coil of the resolver can at the same time be the at least one power transmitter coil (primary coil) of the inductive power transfer path. The at least one primary coil can thus have both an power transfer function and an angular position measuring function.

Accordingly, the magnetic circuit can comprise at least one primary coil (on the stator-side or in/on the stator or (fixedly) connected to the stator) and at least one secondary coil (on the rotor-side or in/on the rotor or (fixedly) connected to the rotor), wherein the primary coil is used or designed both for measuring the angular position of the rotor and for inductive transfer of electric power to a load on the rotor. In other words, the primary coil is part of both the resolver and the inductive power transfer path. Preferably the magnetic circuit comprises a plurality of primary coils, such as 2, 3, 4, 5 or a higher number of primary coils. The angular position to be detected can be determined exactly using two primary coils, for example. Additional primary coils can be used to improve the reliability and accuracy of the resolver and to increase the efficiency of the power transfer. The number of primary coils and/or their arrangement depends on the configuration of the electric machine and/or the overall configuration of the angle measurement (e.g. the angle range to be measured, etc.). The arrangement of the primary coils should preferably be selected such that the primary coils do not permanently or continuously supply redundant information. The arrangement of the primary coils can e.g. not be axially symmetrical in order to prevent opposing coils from supplying the same information.

The at least one primary coil can be designed as a U-core coil, for example.

The at least one primary coil can have at least one electrical property dependent on the angular position of the rotor. The electrical property can e.g. be the inductance of the primary coil. The angular position of the rotor can be determined on the basis of the angle-dependent electrical property (such as inductance) of the at least one primary coil.

In order for the at least one electrical property (such as the inductance) of the primary coil to change as a function of the angular position of the rotor, the resolver can comprise an arrangement that is designed to change the at least one electrical property of the primary coil (such as the inductance) upon rotation of the rotor. The arrangement can comprise at least one magnetic ring made of a magnetic material, which rotates with the rotor. The magnetic ring can e.g. be arranged angularly around the rotation axis of the rotor (rotor axis). The magnetic ring is designed and arranged such that when the rotor rotates, the inductance of the at least one primary coil changes depending on the angular position of the rotor. The inductance of the at least one primary coil is therefore a function of the angular position of the magnetic ring and thus of the rotor.

In particular, when the rotor and the magnetic ring rotating with the rotor are rotated, different areas of the magnetic ring are successively brought into a position lying on the respective primary coil. The magnetic material of the area of the magnetic ring lying on the respective primary coil (i.e. the area that is located in the (immediate) vicinity of the primary coil at a certain angular position of the rotor) influences the inductance of the respective primary coil. An angle-dependent change in the amount, shape and/or arrangement of the magnetic material in the immediate vicinity of the primary coil can thus achieve an angle-dependent change in the inductance of the primary coil, which can be used to measure the angular position of the magnetic ring and thus of the rotor.

The magnetic ring can be designed as a continuous (uninterrupted or solid) ring made of magnetic material. Alternatively, the magnetic ring can comprise a plurality of discrete magnetic elements or magnetic cores (e.g. ferrite cores) arranged in an annular manner. The arrangement can comprise a plurality of magnetic rings arranged, for example, concentrically with one another.

In order to achieve an angle-dependent change in the inductance of the at least one primary coil, different properties of the magnetic ring, such as its shape, cross-section (thickness and/or width), and/or arrangement can be suitably selected.

The magnetic ring can be designed and arranged e.g. such that the discrete magnetic cores or the different areas of the continuous magnetic ring are arranged at different or varying distances from the rotary axis of the rotor (rotor axis) and/or have different shapes (e.g. different thicknesses and/or widths and/or lengths). The angular position of the rotor is encoded by the different or varying distances of the discrete magnetic cores or the different areas of the continuous magnetic ring from the rotor axis and/or by the variation of the magnetic material.

The shape of the magnetic ring can be any shape suitable for changing the inductance of the at least one primary coil during rotation. For example, the shape of the magnetic ring can be substantially elliptical. This arrangement is suitable for an angle measurement in a 180° window. For an angle measurement in a 90° window, for example, a substantially butterfly or diamond-shaped shape with four outward formations is possible. Other non-circular shapes, such as substantially triangular, square, rectangular, etc. shapes are also possible.

The magnetic ring can be centered (i.e. the center point of the magnet ring lies on the rotation axis of the rotor) or eccentric to the rotation axis of the rotor (i.e. the center point of the magnet ring does not lie on the rotation axis of the rotor). In the case of an eccentrically arranged magnet ring, the magnet ring can also be circular and with a constant cross-section (i.e. with a constant thickness and a constant width). Other shapes are also possible.

As described above, upon rotation of the rotor, the discrete magnetic cores or the different areas or points of a continuous magnetic ring are successively brought into a position opposite the at least one primary coil on the stator.

The inductance of the primary coil depends on the distance between the magnetic core or the area of the continuous magnetic ring which is opposite the primary coil, and the at least one winding of the primary coil. If this distance is small, the primary coil has a high inductance. If this distance is large, the primary coil has a low inductance. In the case of a non-circular shape of the magnetic ring and/or an eccentric arrangement of the magnetic ring with respect to the rotation axis of the rotor, this distance changes with the rotation of the rotor, i.e. with the change in the angular position of the rotor. The at least one primary coil consequently has an inductance that varies with the rotation of the rotor and that depends on the angular position of the rotor.

The inductance of the primary coil also depends on the amount of magnetic material of the magnetic core or the area of the continuous magnetic ring which is opposite the primary coil. In the case of a magnetic ring with an angle-dependent varying cross-sectional shape (e.g. with an angle-dependent varying thickness and/or an angle-dependent varying width of the magnetic material or the discrete magnetic cores), this amount changes upon rotation of the rotor, which also leads to an angle-dependent change in the inductance of the primary coil.

The at least one continuous magnetic ring can be manufactured from any desired magnetic solid material, e.g. from ferrite pressed into shape or magnetic plastic, e.g. in an injection molding process. The discrete magnetic cores forming the at least one magnetic ring can also be manufactured from any magnetic material, such as ferrite.

The at least one magnetic ring can be arranged or attached on or in a carrier made of a non-magnetic material (such as plastic). The carrier can be part of the rotor or be (fixedly) connected to the rotor.

In the case of a magnetic ring made of discrete magnetic cores, the number of discrete magnetic cores can vary depending on the application (e.g. the desired angular resolution) and/or the dimensions of the measurement assembly. The shape of the discrete magnetic cores can be selected appropriately. For example, each of the discrete magnetic cores can have a substantially cylindrical shape with a circular, elliptical, square, rectangular, etc. cross section.

The at least one primary coil can be electrically connected to an oscillator or part of an oscillator. If there are several primary coils, each of the primary coils can be electrically connected to an oscillator. As described above, the oscillator generates an alternating current in the at least one primary coil. The alternating field generated by the primary coil penetrates the at least one secondary coil and induces an alternating voltage in it. The induced alternating voltage can be used, e.g. in a rectified manner, to supply the rotor or an electrical load on the rotor.

The resonance frequency of the oscillator depends on the inductance of the at least one primary coil. If the inductance of the respective primary coil changes, the resonance frequency of the corresponding oscillator changes as well. As described above, the inductance of the primary coil can vary and depend on the angular position of the rotor. Consequently, the inductance of the primary coil and thus the angular position of the rotor can be determined from the measured resonance frequency of the oscillator. The resonance frequency of the oscillator can be measured with a suitable frequency meter, which can be part of an inductance measuring device. The frequency meter can e.g. comprise field programmable logic (FPGA). The frequency meter can further comprise a low-pass filter.

The oscillator can be a Royer oscillator, for example. The Royer oscillator comprises a capacitor connected in parallel to the primary coil, which together with the inductance of the primary coil forms a parallel resonant circuit, the parallel resonant circuit substantially operating in the resonance point.

Configurations in which the oscillator comprises a capacitor connected in series with the primary coil are possible as well. A combination of capacitors connected in parallel and in series is also possible.

The power transfer path can furthermore comprise a compensator designed to substantially compensate for a dependency of the induced voltage (i.e. the secondary-side output voltage or the voltage induced in the at least one secondary coil) on the drawn current at least in a predetermined operating range. This makes the secondary output voltage in the specified operating range independent of the current consumption.

Furthermore, the power transfer path can include a rectifier, which can be followed by the compensator.

Furthermore, the device can comprise a low-pass filter, e.g. as a component of the resolver and in particular of the frequency meter. With the low-pass filter, the measurement signal, on the basis of which the angular position of the rotor is determined, can be smoothed in order to remove possible interferences. The cutoff frequency of the low-pass filter can, depending on the application and design of the measuring system, be e.g. in the range from a few Hertz to several tens of kHz (i.e. in the range from approximately 1 Hz to approximately 100 kHz), preferably in the range of a few kHz. The cutoff frequency of the low-pass filter can be e.g. in the range from approximately 1 Hz to approximately 100 kHz, from approximately 100 Hz to approximately 80 kHz, from approximately 1 kHz to approximately 50 kHz. The cutoff frequency of the low-pass filter can in particular be selected so that it is far above the maximum rotor speed to be expected

The rotor can be an internal rotor, i.e. a rotor that is surrounded by the stator. An arrangement with an external rotor that surrounds the stator of the electric machine is possible as well.

Preferred embodiments of the present invention will be described below by way of example with the aid of accompanying figures. Individual elements of the described embodiments are not restricted to the respective embodiment. Instead, elements of the embodiments can be combined with one another in an arbitrary manner and new embodiments can be created thereby. The figures show:

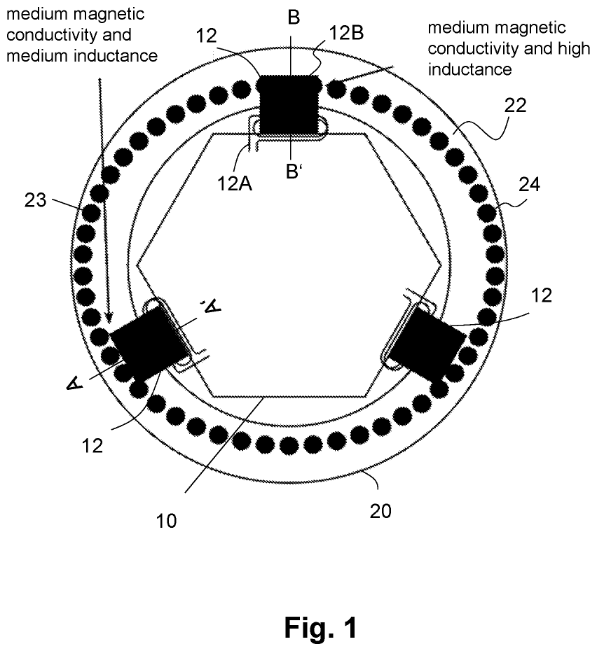

FIG. 1 a schematic view from above of the magnetic circuit of an exemplary resolver for an electric machine;

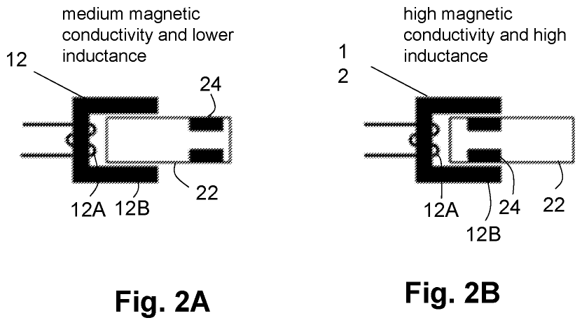

FIGS. 2A and 2B each a sectional view of the magnetic circuit of FIG. 1;

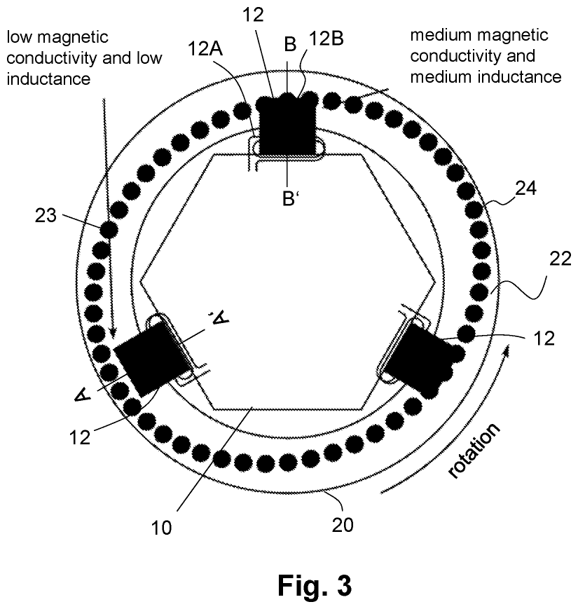

FIG. 3 a schematic view from above of the magnetic circuit of FIG. 1 with a rotation of the rotor by 30° with respect to the rotor position shown in FIG. 1;

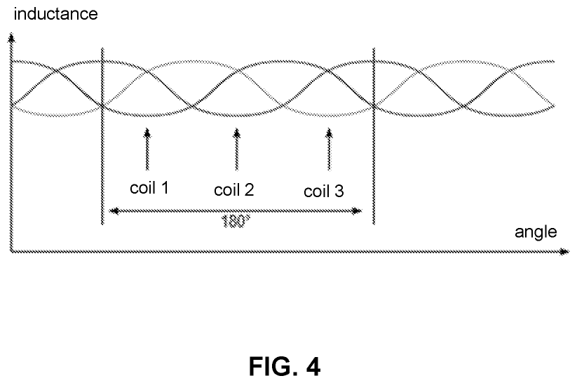

FIG. 4 the inductance profile of the primary coils of the magnetic circuit of FIG. 1 as a function of the rotation angle of the rotor over a 360° rotation of the rotor;

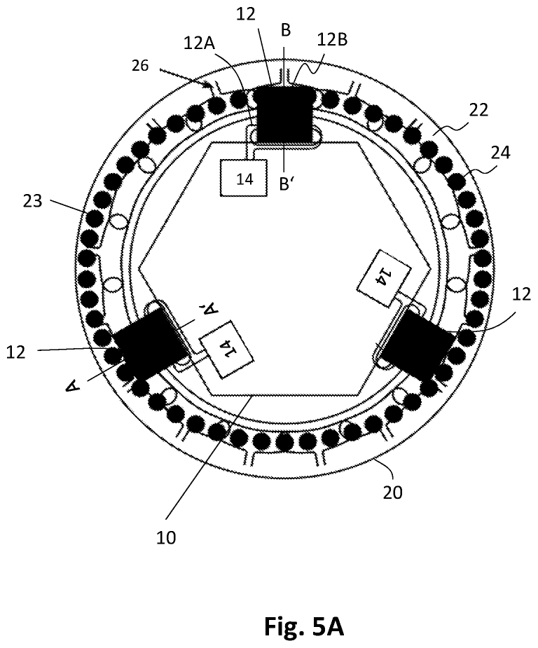

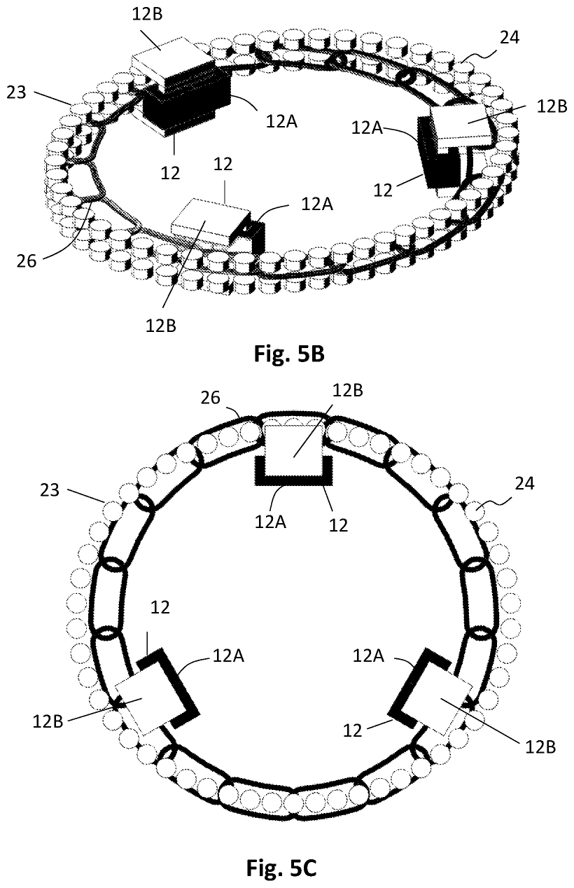

FIG. 5A a schematic view from above of the magnetic circuit of an exemplary device for contactless power transfer to a rotor of an electric machine and for detecting the angular position of the rotor;

FIG. 5B a perspective view of an exemplary device for contactless power transfer to a rotor of an electric machine and for detecting the angular position of the rotor;

FIG. 5C a view from above of the exemplary device shown in FIG. 5B with a combined resolver function and contactless power transfer function to the rotor;

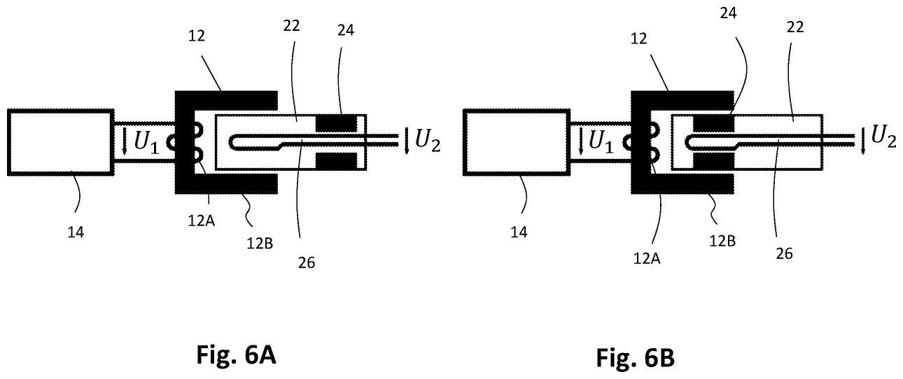

FIGS. 6A and 6B each a sectional view of the magnetic circuit of FIG. 5A;

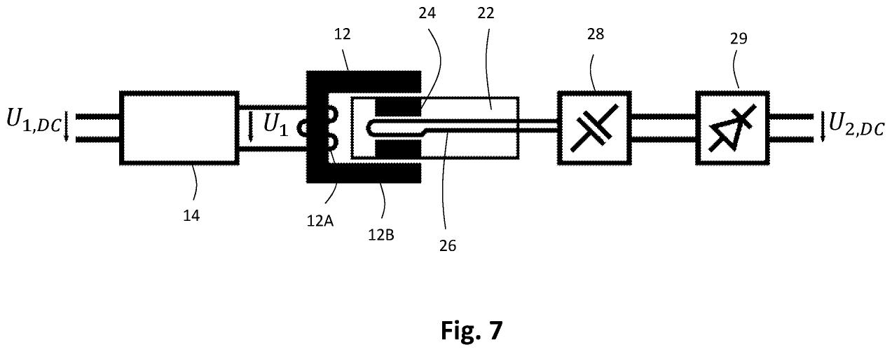

FIG. 7 a sectional view of a magnetic circuit of an exemplary device for contactless power transfer to a rotor of an electric machine and for detecting the angular position of the rotor;

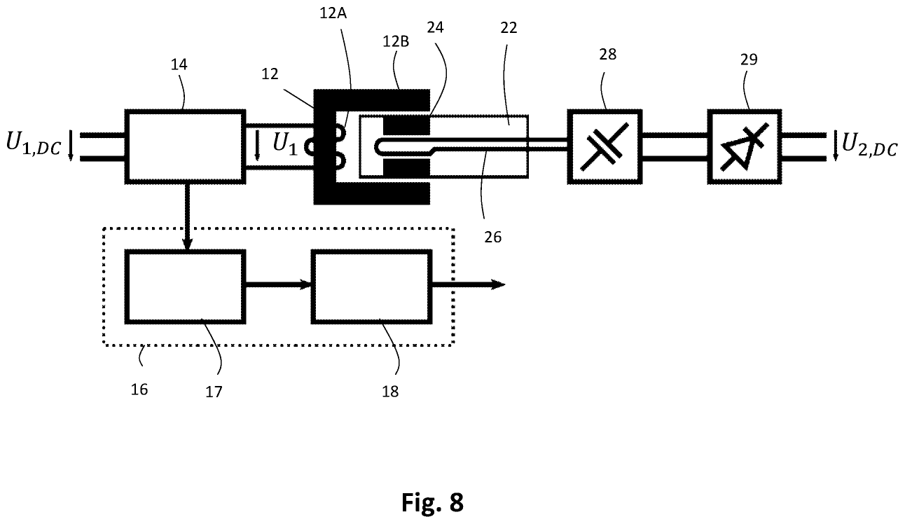

FIG. 8 a block diagram of an exemplary device for contactless power transfer to a rotor of an electric machine and for detecting the angular position of the rotor;

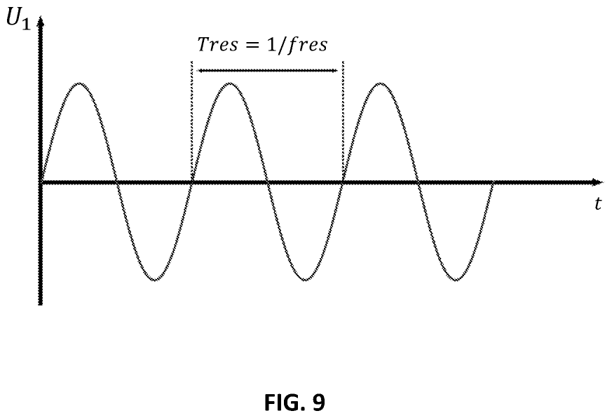

FIG. 9 the voltage profile of the primary-side coil voltage as a function of time;

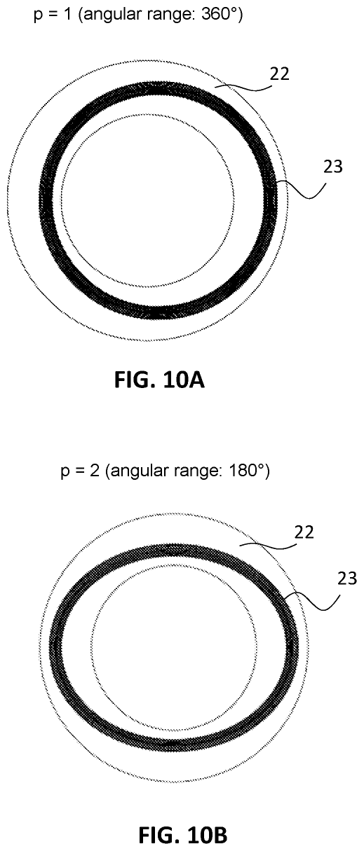

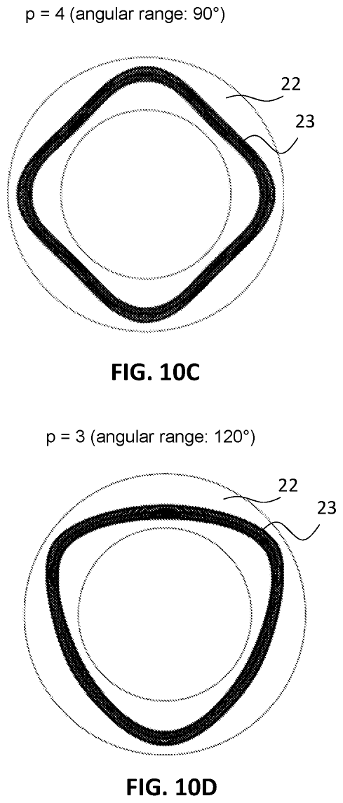

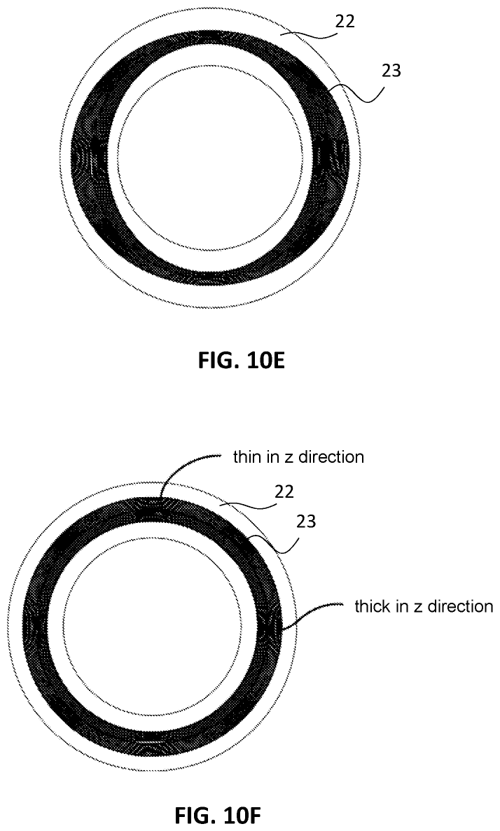

FIGS. 10A to 10F each exemplary embodiments of a magnetic ring; and

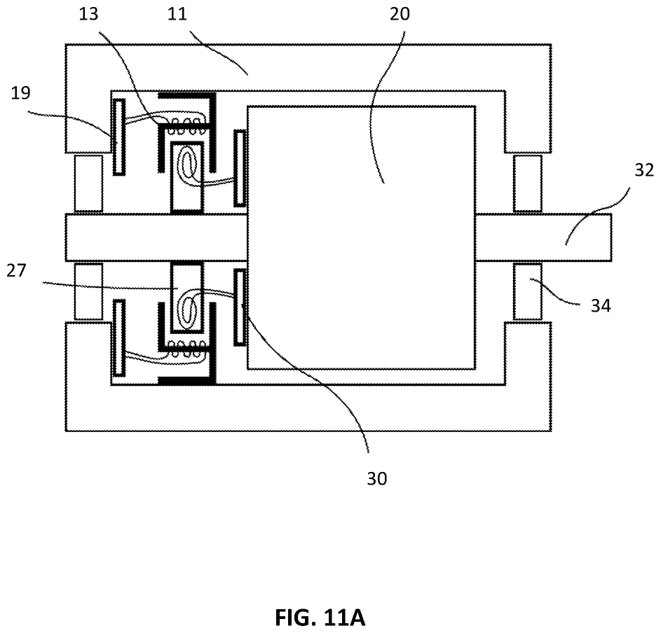

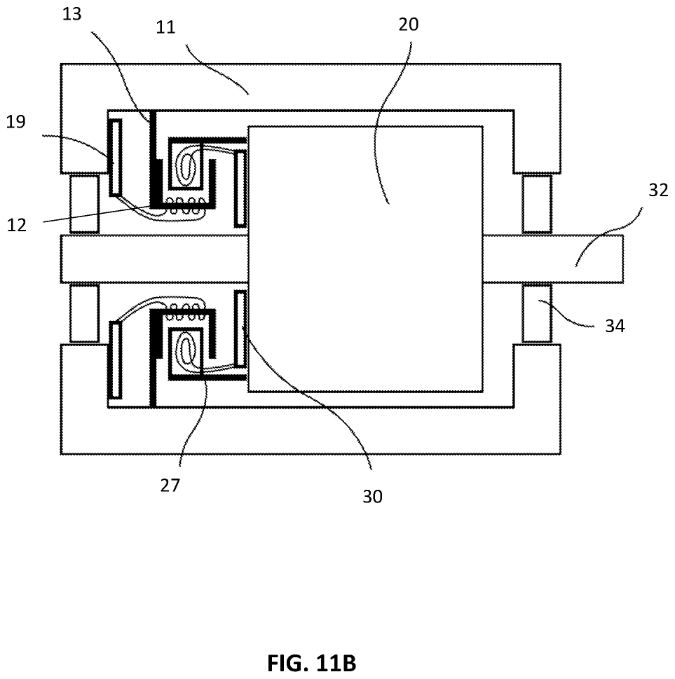

FIGS. 11A and 11B exemplary electric machines with an internal rotor.

### OPERATING PRINCIPLE OF THE RESOLVER

It is the task of a resolver to detect the angular position of a rotating object, such as the rotor of an electric machine. Here, the resolver is to enable an unambiguous determination of the angle within a given angle range. This angle range can be a complete revolution (360°) or an integer part

$$( \frac{1}{n} , n ∈ ℕ )$$

of the complete revolution (e.g. 180°, 120°, . . . ). How large the angle range must be depends on the number of pole pairs of the electric machine used. For example, the resolver can be designed for an application with two pole pairs. In this case, it must be possible to clearly determine the rotation angle in an angle range of 180°.

FIG. 1 shows a schematic representation of the magnetic circuit of a resolver of an exemplary device for contactless power transfer to a load arranged on the rotor of an electric machine and for detecting the angular position of the rotor. The electric machine can be any electric machine, for example a synchronous machine.

The electric machine has a stator (stationary part) 10 and a rotor (non-stationary part) 20. In the example shown in FIG. 1, the rotor is an external rotor.

In the inner area there is located the stator 10 with three attached coils 12. As will be described below, the coils 12 serve to both measure the angular position of the rotor (i.e. the rotation angle of the rotor) and transfer power to the rotor in a non-contact manner. The coils 12 are referred to as primary coils in the context of the present application. In the example shown in FIG. 1, the primary coils 12 are designed as U-core coils. Each of the primary coils 12 comprises at least one winding 12A of an electrical conductor and a C-shaped magnetic core 12B (e.g., a ferrite core). In FIG. 1, the primary coils are viewed from above. The number of the primary coils 12 is not limited to 3 and may be 2, 4, 5, etc., for example. The stator 10 is surrounded by the rotor 20, with an air gap being located between the stator 10 and the rotor 20. The air gap can have a substantially constant thickness. The rotor 20 has a carrier 22 in the form of a ring made of non-magnetic material such as plastic, which surrounds the stator 10. The rotation axis of the carrier 22 coincides with the rotation axis of the rotor (rotor axis). The carrier 22 can also be a separate component that is fixedly connected to the rotor 20 and rotates with the rotor.

Furthermore, a plurality of ferrite cores 24 are arranged or attached in the annular carrier 22 in a manner distributed over the circumference of the carrier 22, the distances between the ferrite cores 24 and the rotation axis of the annular carrier 22 and the rotation axis of the rotor 20 being different. The ferrite cores (exemplary magnetic cores) form a magnetic ring 23.

In the example shown in FIG. 1, the ferrite cores 24 are arranged or introduced in the form of an ellipse. In other words, the magnetic ring 23 formed from the ferrite cores 24 has an elliptical shape. The rotation axis of the rotor intersects the ellipse at its center (i.e. in the middle between the focal points of the ellipse). Other arrangements of the ellipse (such as offset to the rotation axis) and other shapes of the magnetic ring 23 are possible as well. The individual ferrite cores 24 each have a cylindrical shape with a round cross section. Other shapes of the ferrite cores 24, such as ferrite cores with an elliptical, square, rectangular, etc. cross section, are also possible. It is also possible to use other suitable magnetic cores instead of ferrite cores, e.g. made of ferromagnetic metal alloys or other soft-magnetic materials.

Upon rotation of the rotor 10, the ferrite cores 24 are successively brought into a position opposite the respective primary coil 12 on the stator 10. The inductance of the respective primary coil 12 depends on the distance between the magnetic core, which is opposite the primary coil 12, and the at least one winding 12A of the corresponding primary coil 12. Due to the distribution of the ferrite cores in the carrier 22 (e.g. in the form of an ellipse) and the shape of the magnetic ring 23, this distance changes upon rotation of the rotor 10, as shown in FIGS. 2A and 2B. In other words, the distance between the at least one winding 12A of a primary coil 12 and the ferrite core 24 opposite this primary coil 12 varies upon rotation of the rotor 20. The primary coils 12 therefore each have an inductance that changes or varies upon rotation of the rotor, which inductance depends on the rotation angle of the rotor 10.

FIGS. 2A and 2B each show a sectional view of the magnetic circuit of FIG. 1, with FIG. 2A showing a sectional view along the line A-A′ and FIG. 2B showing a sectional view along the line B-B′. As shown in FIG. 2B, the areas in which the ferrite cores 24 can penetrate far into the respective primary coil 12 (i.e. in which the distance between a ferrite core 24 and the winding 12A of the respective primary coil 12 opposite the ferrite core is small) have a high Inductance. Conversely, there is a lower inductance in the areas in which the ferrite cores 24 are located outside the respective primary coil 12 (i.e. in which the distance between a ferrite core 24 and the winding 12A of the respective primary coil 12 opposite the ferrite core 12 is greater), as shown in FIG. 2A.

As described above, the change in the ferrite core distances upon rotation of the rotor 20 results in a change in the primary coil inductances. This is shown by way of example in FIG. 3. Here, the rotor 20 is rotated by 30° counterclockwise with respect to the position shown in FIG. 1.

FIG. 4 illustrates the qualitative profile of the three inductance values of the primary coils 12 over a whole 360° rotation of the rotor. The rotation angle of the rotor is plotted on the abscissa of the diagram shown in FIG. 4 and the inductance of the three primary coils (coil 1, coil 2, coil 3) is plotted on the ordinate. As can be seen from FIG. 4, in the case of a stator 10 with three primary coils 12, the rotor position can be clearly determined within the given angle range of 180°. If a rather unfavorable constellation of coils (e.g. four coils) is used, the inductance profiles of the opposing coils are congruent. As a result, there are only two independent frequency signals available. In this case, a clear assignment in the entire angle range is not possible any more.

The stator 10 can further comprise three-phase windings (not shown) for forming a magnetic rotating field for driving the electric machine in cooperation with an excitation winding (rotor winding, not shown) or with a permanent magnet (not shown) arranged on the rotor 20.

Operating Principle of the Inductive Power Transfer and Inductance Measurement

FIG. 5A shows a schematic view from above of the magnetic circuit of an exemplary device in which the resolver function and the contactless power transfer function are combined. The structure is similar to the structure shown in FIG. 1, with an additional IPT path for realizing the inductive power transfer on a load arranged on the rotor. The IPT line and the resolver are combined in the same magnetic circuit.

In particular, a stator 10 with three primary coils 12 is located in the inner area. The primary coils 12 are U-core coils with a conductor 12A and a magnetic core (e.g. ferrite core) 12B.

The stator 10 is surrounded by a rotor 20. The rotor 20 has an annular carrier 22 made of non-magnetic material such as plastic, which surrounds the stator 10. Furthermore, the rotor 10 has a plurality of ferrite cores 24 arranged or attached in a distributed manner over the circumference of a carrier 22 made of a non-magnetic material, for example in the form of an ellipse, which rotates with the rotor 10. As described in connection with FIG. 1, the ferrite cores 24 form a magnetic ring 23.

To realize the inductive power transfer to a load arranged on the rotor, a large number of secondary coils 26 are arranged or introduced in the rotor 20 or in the carrier 22. The secondary coils can e.g. be arranged annularly or circularly around the rotation axis of the rotor 20 or the carrier 22. In the example shown in FIG. 5A, the number of additional secondary coils is 17. A lower or higher number of secondary coils is also possible. The number of secondary coils can be selected to be at least high enough so that they do not influence one another. In order to achieve a high degree of efficiency in power transfer, it can be advantageous not to select too high a number of secondary coils. An optimal design can e.g. have a slightly smaller number of secondary coils than 17.

In addition, the primary coils 12 are each electrically connected to an oscillator 14 or, together with other elements, form an oscillator. The oscillator 14 generates an alternating current in the respective primary coil 12, which generates an alternating magnetic field. The outer coils in the rotor (i.e. the secondary coils 26) are permeated with the alternating magnetic field, which induces an alternating voltage in the secondary coils 26. The induced voltage can be rectified and used for the electrical supply of a load arranged on the rotor 20, such as the rotor winding or a sensor arranged on the rotor 20.

FIG. 5B shows a perspective view and FIG. 5C shows a view from above of the ferrite core arrangement with the primary coils 12 and the secondary coils 26 of the exemplary device shown in FIG. 5A with combined resolver function and contactless power transfer function to a load on the rotor.

For better illustration, a sectional view of the structure shown in FIG. 5A is also shown in FIG. 6.

In particular, FIG. 6A shows a sectional view of the magnetic circuit of FIG. 5A along the line A-A′ as a block diagram. FIG. 6B shows a sectional view of the magnetic circuit of FIG. 5A along the line B-B′ as a block diagram. In FIG. 6B, the distance between the ferrite core 24 and the respective primary coil 12 opposite the ferrite core 24 is small and the inductance of the primary coil 12 is correspondingly high (cf. FIG. 2B). In FIG. 6A, the distance between the ferrite core 24 and the respective primary coil 12 opposite the ferrite core is large and the inductance of the primary coil 12 is correspondingly small (cf. FIG. 2A).

The oscillator 14 can e.g. be a Royer oscillator. The Royer oscillator comprises a capacitor C₁ connected in parallel to the respective primary coil 12, which together with the inductance L₁ of the primary coil 12 forms a parallel resonant circuit. This type of oscillator operates the resonant circuit formed from L₁ and C₁ exclusively in the resonance point. The resonance frequency fᵣₑₛ at which the oscillator oscillates depends on L₁ and C₁:

$${f}_{r e s} = \frac{1}{2 π \sqrt{{L}_{1} {C}_{1}}} \qquad ( 1 )$$

The Royer oscillator 14 is supplied with power from a direct voltage source, which is converted internally into an alternating voltage. The following relationship applies between the input-side DC voltage U_{1,DC} and the output-side AC voltage U₁:

$${U}_{1} = \frac{π}{\sqrt{2}} {U}_{1 , DC} \qquad ( 2 )$$

The alternating magnetic field generated by the primary coil 12 penetrates the secondary coil 26 on the rotor 20 and induces an alternating voltage in the secondary coil 26. The voltage U₁ applied to the primary coil 12 and the voltage U₂ induced in the secondary coil 26 are related as follows:

$${U}_{2} = k \cdot \sqrt{\frac{{L}_{2}}{{L}_{1}}} \cdot {U}_{1} \qquad ( 3 )$$

In the above equation:

L₁ designates the inductance of the primary coil 12;
L₂ designates the inductance of the secondary coil 26; and
k designates the magnetic coupling factor of the primary and secondary coils. In contactless inductive power transfer, this value is usually between 0.1 and 0.5, for example around 0.3.

With a given coupling factor k, the output voltage of the inductive power transfer path can be defined via the ratio of the inductance values L₁ and L₂. Depending on the required voltage on the load in the rotor 20, the inductance ratio L₁/L₂ can be adapted to the circumstances by changing the number of turns of the secondary and/or primary coil(s).

According to the above equations, the following equation results for the voltage U₂ induced on the rotor side:

$${U}_{2} = k \cdot \sqrt{\frac{{L}_{2}}{{L}_{1}}} \cdot \frac{π}{\sqrt{2}} {U}_{1 , DC} \qquad ( 4 )$$

Due to a non-ideal coupling of the coil pair (for example k≈0.3), the secondary-side output voltage U₂ depends on the drawn current. To compensate for this, the power transfer path can be compensated for on the secondary side. A corresponding compensator 28 can be provided for this purpose. This measure makes the output voltage substantially independent of the current consumption in all relevant operating ranges. Since a DC voltage is usually required on the rotor 20, a rectifier 29 (such as a bridge rectifier) can be connected downstream of the actual IPT path. A block diagram of the resulting configuration is shown in FIG. 7. FIG. 7 shows a sectional view of a magnetic circuit similar to the magnetic circuit shown in FIG. 5A or 8, supplemented by secondary-side compensation by means of a compensator 28 and by a rectifier 29.

The voltage U_{2,DC} applied at the output of the rectifier 29 can be calculated as follows:

U_{2,DC}≅0.9U₂ (5)

For the relationship between input voltage U_{1,DC} and output voltage U_{2,DC} there results:

$${U}_{2 , DC} ≅ 0.9 k \cdot \sqrt{\frac{{L}_{2}}{{L}_{1}}} \cdot \frac{π}{\sqrt{2}} {U}_{1 , D C} \qquad ( 6 )$$

### Inductance Measurement

As described above, the inductance L₁ of the respective primary coil 12 depends on the rotor angle. As a result, the resonance frequency fᵣₑₛ of the corresponding oscillator 14 also changes. The following relationship results between the resonance frequency fᵣₑₛ and the inductance L₁:

$${f}_{r e s} ∝ \frac{1}{\sqrt{{L}_{1}}} or {f}_{r e s} = d \frac{1}{\sqrt{{L}_{1}}} \qquad ( 7 )$$

The factor d is a design-dependent constant. Correspondingly, the inductances of the respective primary coils 12 can be determined from the measured frequency of the oscillators 14. This method can be implemented very precisely with limited resources, since frequencies can be easily measured. A common method in practice is frequency measurement using programmable logic (FPGA).

FIG. 8 shows a block diagram of an exemplary device for contactless power transfer to a load arranged on the rotor of an electric machine and for detecting the angular position of the rotor. The device comprises a power transfer path (IPT path) and a frequency meter 16 comprising a programmable logic (FPGA) 17 for frequency measurement and a low-pass filter 18.

FIG. 9 shows the voltage profile of the primary-side coil voltage (i.e. the voltage U₁ of the primary coil 12) as a function of time t. The voltage profile varies with a period duration Tᵣₑₛ.

As shown in FIGS. 8 and 9, the frequency signal of the Royer oscillator 14 is fed to the frequency meter 16 with the programmable logic (FPGA) 17 and the frequency or period duration of the respective oscillator is reconstructed therefrom by time measurement. The result obtained can then be filtered with a low-pass filter 18 in order to remove possible interference. A lower cutoff frequency of the low-pass filter 18 has an advantageous effect on the robustness of the measuring arrangement, but can reduce the dynamics of an entire control system (not shown) in which the resolver is used as a sensor.

Since the current position of the rotor is to be determined from the interaction of the individual frequencies of the oscillators, it is advantageous if the measuring arrangement can respond quickly to a change in frequency. The cutoff frequency of the low-pass filter 18 is preferably selected so that it is far above the maximum rotor speed to be expected. The cutoff frequency of the low-pass filter 18 can e.g. be in the range from a few tens of Hz to several tens of kHz.

It is irrelevant which signal is tapped off at the Royer oscillator 14 to measure the resonance frequency. As shown in FIG. 9, the resonant circuit voltage U₁ could be used for this. Depending on the design, this voltage can be relatively high and can only be measured indirectly. Alternatively, the control voltage of a power semiconductor can also be used for evaluation.

In the above examples, the rotor 20 surrounds the stator 10. An arrangement with an internal rotor 20, which is surrounded by the stator 10, is also possible.

In the above examples, the magnetic ring 23 is formed from discrete magnetic elements (magnetic cores). The magnetic ring 23 can also be designed as a continuous magnetic ring. Furthermore, in the above examples, the ferrite cores are arranged in an elliptical shape. Other configurations in which the distance between the ferrite core/magnetic material and the primary coil opposite the ferrite core/magnetic material and/or the amount of magnetic material in the surrounding of the primary coil and thus the inductance of the primary coil changes with the rotation angle to be measured are also possible.

FIGS. 10A to 10F show further exemplary embodiments of a magnetic ring. In FIGS. 10A to 10F, the magnetic ring 23 is designed as a continuous magnetic ring. Instead of the continuous magnetic ring 23, it is also possible to use a magnetic ring which, as described above, is formed from discrete magnetic cores.

FIG. 10A shows a carrier 22 with a circular magnetic ring 23, which is arranged eccentrically or offset to the rotation axis of the rotor. This arrangement is suitable for an angle measurement in a 360° window or angle range (360°/p, p=1).

FIG. 10B shows a carrier 22 with an elliptical magnetic ring 23 which is arranged concentrically to the rotation axis of the rotor. The rotation axis of the rotor intersects the ellipse at its center. This arrangement is suitable for an angle measurement in a 180° window or angle range (180°/p, p=2).

FIG. 10C shows a carrier 22 with a magnetic ring 23 with an essentially square shape, which has four rounded edges or formations toward the outside (butterfly shape). This arrangement is suitable for an angle measurement in a 90° window or angle range (360°/p, p=4).

FIG. 10D shows a magnet ring 23 with an essentially triangular shape with three rounded edges or formations toward the outside. This arrangement is suitable for an angle measurement in a 120° window or angle range (360°/p, p=3).

Other shapes with a different number of edges or formations toward the outside (e.g. 2, 5, 6, etc.) are possible as well.

In the examples shown in FIGS. 10A to 10D, the thickness and the width of the magnetic ring 23 are essentially constant. In other words, the magnetic rings shown in FIGS. 10A and 10D have a substantially constant, angle-independent cross section. The thickness and/or the width of the magnetic ring 23 can, however, be variable and thus encode the angular position of the rotor.

FIG. 10E shows an elliptical magnetic ring 23 arranged concentrically to the rotation axis of the rotor, the width of the magnetic ring or the width of the magnetic material changing with the angle. This arrangement is suitable for an angle measurement in a 180° window or angle range (180°/p, p=2).

FIG. 10F shows a circular magnetic ring 23 arranged concentrically to the rotation axis of the rotor, the thickness of the magnetic ring changing in the z-direction with the angle. The z-direction is the direction perpendicular to the plane in which the magnetic ring 23 lies. This arrangement is also suitable for an angle measurement in a 180° window or angle range (180°/p, p=2).

Due to the arrangement of the magnetic ring 23 with respect to the rotation axis of the rotor, the shape of the magnetic ring and/or the distribution of the magnetic material of the magnetic ring, the inductance of each of the primary coils changes upon rotation of the rotor and the magnetic ring rotating with the rotor, the inductance being dependent on the angular position of the rotor. Thus, as described above, the angular position of the rotor can be determined.

The above-described devices for contactless power transfer to a load arranged on the rotor of an electric machine and for detecting the angular position of the rotor can be used in an electric machine (e.g. a motor or a generator). The electric machine can in particular be a synchronous machine.

The electric machine can be an electric machine with an external rotor, as shown in FIGS. 1 to 5B. With this design, the stationary part (stator) of the machine is located inside and is surrounded by the moving part (rotor).

The electric machine can also be an electric machine with an internal rotor. With this design, the rotating part (rotor) of the machine is located inside and is surrounded by the stationary part (stator). FIGS. 11A and 11B each show exemplary electric machines 1 with an internal rotor. In particular, FIGS. 11A and 11B each show a section along the rotation axis of the rotor.

Each of the electric machines 1 shown in FIGS. 11A and 11B comprises a stator with a housing (stator housing) 11. The rotor 20 is located inside the stator housing 11 or is surrounded by the stator housing 11. The rotor 20 is mounted on the rotor shaft 34 by means of bearings 34. The rotation axis of the rotor shaft 34 coincides with the rotation axis of the rotor 10.

As described above, the electric machine further comprises a plurality (for example 2, 3, 4, etc.) of primary coils, which are used both for contactless power transfer and for measuring the angular position of the rotor. The primary coils can be designed as U-core coils and have a winding and a C-shaped magnetic core. To hold the primary coils, corresponding brackets are attached or arranged on the stator housing 11. In FIGS. 11A and 11B, the reference number 13 denotes the respective primary coil (with winding and magnetic material) and the associated holder.

Each of the primary coils is electrically connected to an oscillator/inverter and, if applicable, to further electrical or electronic components. The inverter and, if applicable, the further electrical or electronic components are part of a primary electronics assembly 19 attached or arranged in or on the stator housing 11. Furthermore, an electronic arrangement (not shown) for determining the angular position of the rotor 10 can be attached or arranged in or on the stator housing 11. The electronic assembly for determining the angular position of the rotor can, as described above, comprise a frequency meter with a programmable logic and optionally a low-pass filter and other electronic components. The electronic arrangement for determining the angular position of the rotor 10 can be integrated in the primary electronics assembly 19.

The electric machine further comprises a plurality of secondary coils arranged annularly around the rotation axis of the rotor. As described above, the secondary coils are used to transfer inductive power to a load on the rotor 10. Each of the secondary coils can comprise at least one winding made of an electrical conductor and a magnetic core made of a soft-magnetic material (e.g. ferrite). To hold the secondary coils 26, there are provided corresponding holders that are attached or arranged on the rotor 10 or are connected to the rotor 10. In FIGS. 11A and 11B, the reference numeral 27 denotes the respective secondary coil (with winding and magnetic material) and the associated holder.

Each of the secondary coils is electrically connected to a secondary electronics assembly 30. The secondary electronics assembly 30 comprises, for example, a rectifier and optionally a compensator. The secondary electronics assembly 30 is attached in or on the rotor 10.

The electric machine further comprises a magnetic ring (not shown) made of magnetic material, which rotates with the rotor. As described above, the magnet ring is designed and arranged to vary the inductance of each of the primary coils as a function of the angular position of the rotor. As shown in FIGS. 1 to 5B, the ring magnet can be arranged around the primary coils (i.e., the primary coils are located within the ring magnet). The primary coils can also be arranged outside the magnetic ring.

The examples shown in FIG. 11A and in FIG. 11B differ essentially in the arrangement of the primary coils with the corresponding brackets 13 in relation to the secondary coils with the corresponding brackets 27. In the electric machine shown in FIG. 11, the primary coils with the corresponding brackets 13 are arranged further outside in the radial direction with respect to the secondary coils with the corresponding brackets 27. Upon rotation of the rotor, the secondary coils engage the fork-shaped holders of the primary coils “from the inside”. The radial direction is a direction perpendicular to the rotation axis of the rotor or perpendicular to the rotary shaft 34.

In the electric machine shown in FIG. 11B, the primary coils with the corresponding holders 13 are arranged further inward in the radial direction with respect to the secondary coils with the corresponding holders 27. Upon rotation of the rotor, the secondary coils engage the fork-shaped holders of the primary coils “from the outside”. Other suitable arrangements of the primary and secondary coils and the corresponding brackets are also possible.

### REFERENCE NUMERAL LIST

10 stator
11 stator housing
12 primary coil
12A winding of the primary coil from an electrical conductor
12 magnetic core (e.g. ferrite core) of the primary coil
13 primary coil with bracket
14 oscillator (e.g. Royer oscillator)
16 frequency meter
17 programmable logic (FPGA)
18 low-pass filter
19 primary electronics assembly
20 rotor
22 carrier made of non-magnetic material (rotor carrier)
23 magnetic ring
24 magnetic core(s) (e.g. ferrite core(s))
26 secondary coil
27 secondary coil with holder
28 compensator
29 rectifier
30 secondary electronics assembly
32 rotor shaft
34 bearings

1. A device, comprising:
an inductive power transfer path for the inductive transfer of electric power to an electrical load arranged on a rotor of an electric machine; and
a resolver for detecting an angular position of the rotor,
wherein the inductive power transfer path and the resolver use one magnetic circuit.

2. The device according to claim 1, wherein the magnetic circuit comprises at least one primary coil and at least one secondary coil, wherein the at least one primary coil is used both for measuring the angular position of the rotor and for the inductive transfer of electric power to the at least one secondary coil.

3. The device according to claim 2, wherein the resolver comprises:
an arrangement with at least one magnetic ring made of a magnetic material, wherein the magnetic ring is arranged so as to rotate together with the rotor, and wherein the magnetic ring is designed and arranged such that upon a rotation of the rotor the inductance of the at least one primary coil changes as a function of the angular position of the rotor.

4. The device according to claim 3,
wherein the magnetic ring is a continuous magnetic ring,
wherein different areas of the magnetic ring are arranged at different distances from the rotation axis of the rotor and/or have different cross-sectional shapes; or
wherein the magnetic ring is formed from a plurality of magnetic cores arranged at different distances from the rotation axis of the rotor and/or having different shapes.

5. The device according to claim 3, wherein the magnetic ring has a substantially elliptical, triangular, square or other non-circular shape.

6. The device according to claim 3, wherein the magnetic ring is arranged in a manner offset to the rotation axis of the rotor.

7. The device according to claim 3,
wherein the magnetic ring is a continuous magnetic ring formed from ferrite or from magnetic plastics; and/or
wherein the magnetic ring is formed from a plurality of magnetic cores, the magnetic cores being ferrite cores.

8. The device according to claim 2, further comprising:
at least one oscillator electrically connected to the at least one primary coil; and
a frequency meter for measuring the resonance frequency of the at least one oscillator.

9. The device according to claim 8, wherein the oscillator is a Royer oscillator.

10. The device according to claim 1,
wherein the power transfer path comprises a compensator and/or a rectifier; and/or
wherein the resolver comprises a low-pass filter.

11. The device according to claim 1, wherein the rotor is an internal rotor.

12. An electric machine, comprising:
a rotor;
a stator; and
a device, comprising:
an inductive power transfer path for the inductive transfer of electric power to an electrical load arranged on the rotor of the electric machine; and
a resolver for detecting an angular position of the rotor,
wherein the inductive power transfer path and the resolver use one magnetic circuit.

13. The electric machine according to claim 12, wherein the electric machine is a synchronous machine.

14. A method for contactless power transfer to an electrical load arranged on a rotor of an electric machine and for detecting the angular position of the rotor, the method comprising:
operating a device, comprising:
an inductive power transfer path for the inductive transfer of electric power to an electrical load arranged on the rotor of the electric machine; and
a resolver for detecting an angular position of the rotor,
wherein the inductive power transfer path and the resolver use one magnetic circuit;
transferring contactless power to the electrical load arranged on the rotor; and
detecting of the angular position of the rotor using the device.
